(19) United States
(12) Patent Application Publication
(10) Pub. No.: US 2020/0078238 A1
(43) Pub. Date: Mar. 12, 2020

(54) LIFTING DEVICE AND LIFTING BED HAVING THE SAME

(71) Applicant: TUNG KENG ENTERPRISE CO., LTD., Taichung City (TW)

(72) Inventor: CHIA-YEN HUANG, Taichung City (TW)

(73) Assignee: TUNG KENG ENTERPRISE CO., LTD., Taichung City (TW)

(21) Appl. No.: 16/129,416

(22) Filed: Sep. 12, 2018

(51) Int. Cl. A61G 7/012; A61G 7/018

(52) U.S. Cl. CPC A61G 7/012; A61G 7/05; A61G 2203/10; A61G 7/018

(57) ABSTRACT

A lifting device is applied to a multi-plate equipped apparatus to control a part of plates of the multi-plate equipped apparatus to rise or go down, and includes a push rod assembly, a retractable shaft, a motor, and a lifting mechanism, wherein the motor drives the retractable shaft to extend or retract. An end of the retractable shaft is connected to the push rod assembly. The push rod assembly is operatively coupled to the plates, so that during the driving process by the retractable shaft, the plates could be lifted smoothly by the guidance of the lifting mechanism.

### BACKGROUND OF THE INVENTION

### Technical Field

The present invention relates generally to a plate lifting device and a lifting bed, and more particularly to a plate lifting device, which could smoothly lift a plate of a multi-plate equipped apparatus, and a lifting bed with the plate lifting device.

### Description of Related Art

Electric lifting beds are commonly used in the medical or rehabilitation field, and its bed surface consists of a plurality of plates, wherein a lifting device is disposed below the plates to respectively lift the plates, whereby to support the user's back or legs, so that the user can change his posture easily. The lifting device has a retractable shaft and a driven member, which are arranged opposite to each other. For instance, the retractable shaft, which is adapted to lift the plate under the user's leg, is pivotally connected to a base of the lifting bed adjacent to the tail of the lifting bed, and the driven member is pivotally connected to the base of the lifting bed at a position below the user's hip when the user lies on the lifting bed. The retractable shaft is connected to a free end of the driven member. An end of the retractable shaft, which is pivotally connected to the base, is connected to a motor, wherein the motor could control the retractable shaft to extend or retract.

When the user wants to adjust a height of the lifting bed on which the user's lie his legs, the motor could be controlled by a controller to drive the retractable shaft to extend, and the extended retractable shaft pushes the driven member, so that the retractable shaft and the driven member rotate in a direction away from the base, and a junction between the retractable shaft and the driven member moves upward, whereby to push the plate, which is located above the retractable shaft and the driven member, to move. In this way, the plate on the tail of the lifting bed could be raised to support the user's legs.

If the tail of the lifting bed has already been raised, the retractable shaft and the driven member are deflected upwards, so that the vertical component of the force exerted by the motor which pushes the retractable shaft is larger. In such a condition, the tail of the lifting bed could be easily raised. However, if the lifting bed is in a horizontal state, the force exerted by the motor which pushes the retractable shaft is almost only the horizontal component. In such a condition, the lifting bed is hard to be lifted, and the push between the retractable shaft and the driven member during the lifting process may cause damage to the lifting device.

In addition, a multi-plate equipped apparatus that has similar functions with a lifting bed and uses a similar lifting device may also have such problems. Therefore, there is a need for the manufacturers to develop a new type of plate lifting device to solve the aforementioned problems.

### BRIEF SUMMARY OF THE INVENTION

In view of the above, the primary objective of the present invention is to provide a plate lifting device, which could be applied to a multi-plate equipped apparatus and could smoothly lift a plate of the multi-plate equipped apparatus.

The present invention provides a plate lifting device, which is applied to a lifted object, including a base, a push rod assembly, a retractable shaft, a motor, and a lifting mechanism, wherein the push rod assembly includes a first push rod and a second push rod. The first push rod extends toward a first direction and includes a first end and a second end. The first end is slidable and is pivotally connected to the base. A movable member is disposed on the second end and is operatively coupled to the lifted object. The second push rod is connected to the first push rod at where between the first end and the second end and extends toward a second direction which is perpendicular to the first direction. An end of the retractable shaft is pivotally connected to the second push rod. The retractable shaft is capable of extending toward the second push rod to push the second push rod, and is capable of retracting in an opposite direction to pull the second push rod. The motor drives the retractable shaft to extend or retract. The lifting mechanism corresponds to the movable member and is disposed on the base, wherein when the motor drives the retractable shaft to extend from an initial state, the retractable shaft abuts against the second push rod, so that the movable member is in contact with the lifting mechanism and is lifted by the lifting mechanism, whereby the lifted object is raised by the movable member.

In addition, the another primary objective of the present invention is to provide a lifting bed, which could be smoothly lifted under a horizontal state.

The present invention further provides a lifting bed, which includes a base, a plurality of plates disposed on the base, and the abovementioned plate lifting device which is disposed between the base and the plates.

With the aforementioned design, the disclosure of the present invention could smoothly lift the plate when the lifting bed is under the horizontal state.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the lifting bed of an embodiment according to the present invention;

FIG. 2 is a schematic view, showing the lifting bed shown in FIG. 1 is in a state of use;

FIG. 3 is a side view of FIG. 2;

FIG. 4 is a partially schematic view of the lifting bed shown in FIG. 1;

FIG. 5 is a schematic view, showing the push rod assembly of the lifting bed shown in FIG. 1;

FIG. 6 is a sectional view along the 6-6 line in FIG. 4;

FIG. 7 is a partially sectional view, showing the lifting mechanisms of the lifting bed shown in FIG. 6 lifts the movable member;

FIG. 8 is a partially sectional view, showing the lifting mechanisms of the lifting bed shown in FIG. 6 lifts the movable member;

FIG. 9 is a partially sectional view, showing the lifting mechanisms of the lifting bed shown in FIG. 6 lifts the movable member;

FIG. 10 is a schematic view, showing another part of the lifting bed shown in FIG. 1;

FIG. 11 is a schematic view, showing the push rod assembly of the lifting bed shown in FIG. 10;

FIG. 12 is a sectional view along the 12-12 line in FIG. 10;

FIG. 13 is a partially sectional view, showing the lifting mechanisms of the lifting bed shown in FIG. 10 lifts the movable member; and

FIG. 14 is a partially sectional view, showing the lifting mechanisms of the lifting bed shown in FIG. 10 lifts the movable member.

### DETAILED DESCRIPTION OF THE INVENTION

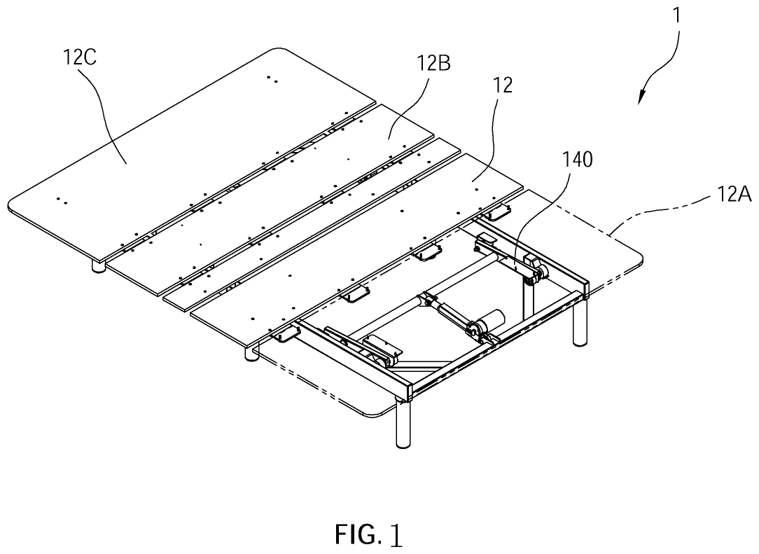

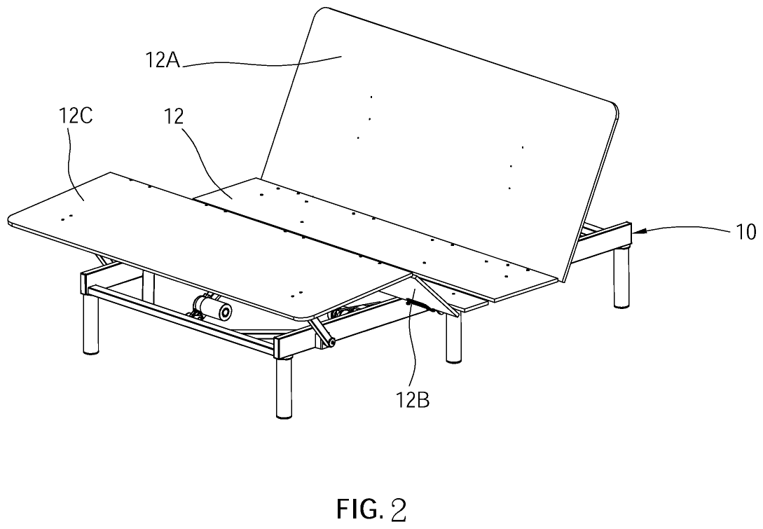

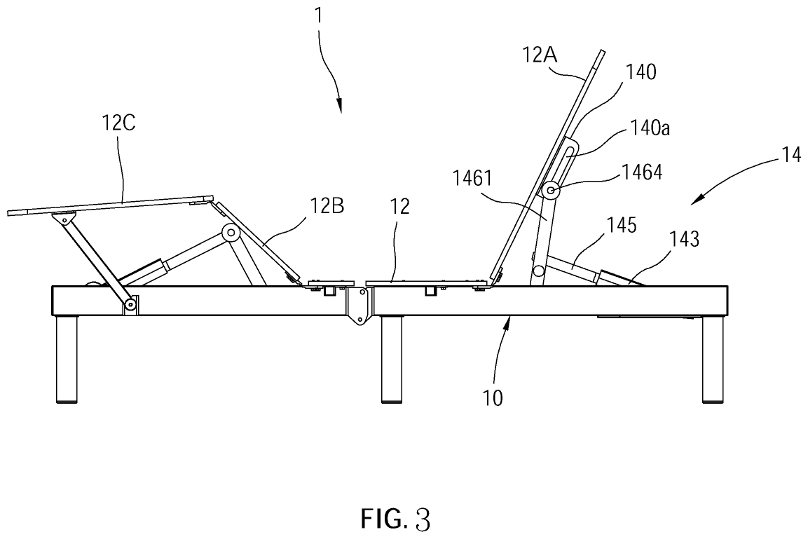

A lifting bed 1 of an embodiment according to the present invention is illustrated in FIG. 1 to FIG. 3, wherein the lifting bed 1 includes a base 10, a plurality of plates 12, and a plate lifting device 14. The plates 12 are disposed on the base 10. The plate lifting device 14 is disposed between the base 10 and the plates 12. FIG. 1 shows that the plates 12 are in a flattened state. FIG. 2 and FIG. 3 show that the plates 12 are manipulated to be inclined. A plate 12A is adapted for being leaned against by a user's back, and a plate 12B and a plate 12C are adapted to support the user's legs. It shall be noted that, the lifting bed 1 of the current embodiment is not limited to be an electric lifting bed for medical treatment or rehabilitation, but could be any multi-plate equipped apparatus with similar structure or function. In addition, the plates are defined as a lifted object of the present invention, however, the lifted object of the present invention is not limited by the plates.

The plate lifting device is adapted to manipulate the plate 12A or the plate 12B and the plate 12C, wherein two ends of another plate 12 are respectively connected to an end of the plate 12A and an end of the plate 12B, so that the plate 12A fulcrums at a joint between the plate 12A and the another plate 12, and the plate 12B fulcrums at a joint between the plate 12B and the another plate 12. Another end of the plate 12A and another end of the plate 12B could be raised. An end of the plate 12C is connected to the another end of the plate 12B. The plate lifting device 14 for manipulating the plate 12A is used for illustration first as follows.

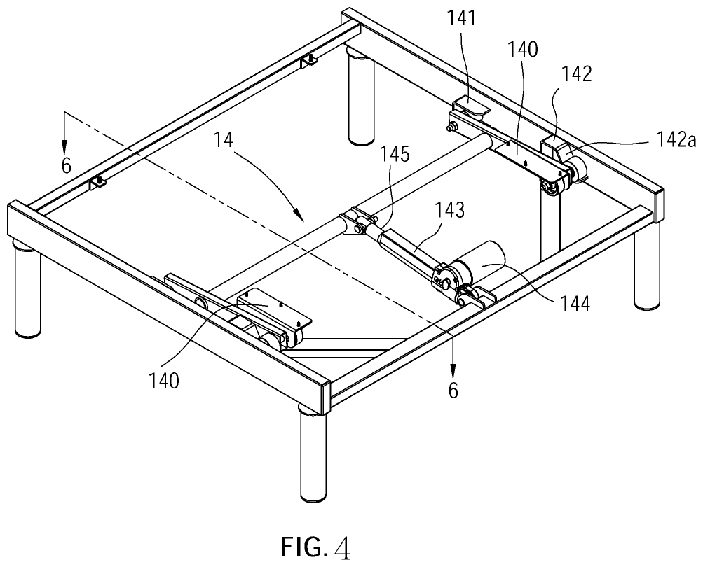

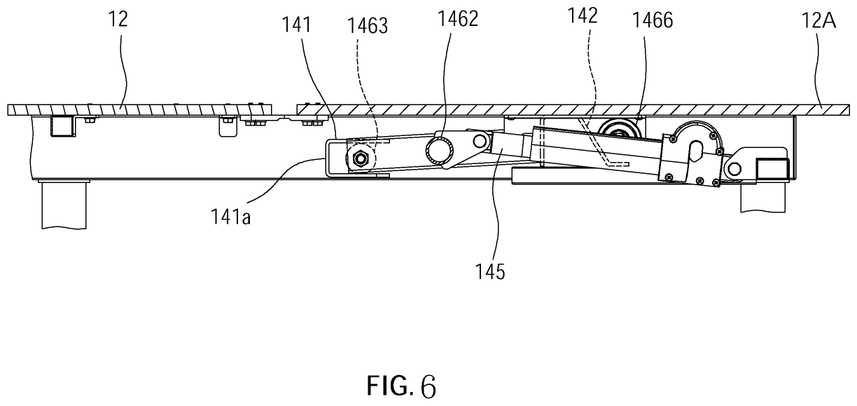

As shown in FIG. 4 to FIG. 6, the plate lifting device 14 for manipulating the plate 12A includes two driven members 140, two restricting members 141, two lifting mechanisms 142, an axle tube 143, a motor 144, a retractable shaft 145, and a push rod assembly 146, wherein the driven members 140 are connected to a bottom surface of the plate 12A and are respectively provided on two sides of the plate 12A. Each of the driven members 140 has an elongated hole 140a. The restricting members 141 are respectively connected to two sides of the base 10 and are surrounded by a plurality of side plates, which are arranged in a U-shaped, to form a sliding space therein. As shown in FIG. 6, one of the side plates 141a which stands erect is defined as an abutted portion. The lifting mechanisms 142 are disposed on the base 10, wherein each of the lifting mechanisms 142 is adjacent to the corresponding one of the restricting members 141, and is a metal plate bent to include a slope 142a with an inclined plane. In addition, an end of the axle tube 143 of the plate lifting device 14 is pivotally connected to the base 10 and is connected to the motor 144. The retractable shaft 145 movably passes through the axle tube 143 and is driven by the motor 144 to extend or retract relative to the axle tube 143. In practice, the motor 144 could be controlled by a controller in a wired or wireless manner

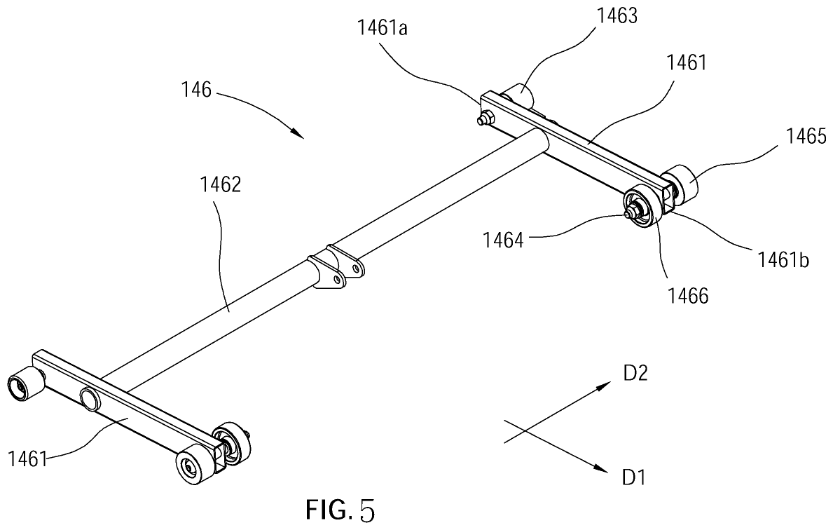

As shown in FIG. 5, the push rod assembly 146 includes two first push rods 1461 and a second push rod 1462, wherein the first push rods 1461 extend toward a first direction D1 and include a first end 1461a and a second end 1461b. In the current embodiment, each of the first ends 1461a is connected to a pivoting member 1463 which is a roller as an example, wherein each of the pivoting member 1463 is located in the sliding space of the corresponding restricting member 141 and is slidable. Each of the second ends 1461b passes through the elongated hole 140a of the corresponding driven member 140 via a shaft 1464, and is connected to a movable member 1465 which is a roller as an example. However, the pivoting member 1463 is not limited by the roller, and the movable member 1465 is not limited by the roller, either. The other end of the shaft 1464 is capable of being connected to a roller 1466. The second push rod 1462 extends toward a second direction D2 which is perpendicular to the first direction D1, wherein two ends of the second push rod 1462 are respectively connected to the first push rods 1461 at where between each of the first ends 1461a and each of the second ends 1461b. An end of the retractable shaft 145 is pivotally connected to a middle portion of the second push rod 1462. The inclined plane of the slope 142a of each of the lifting mechanisms 142 faces a direction away from the first end 1461a of the corresponding first push rod 1461. In other embodiments, the shaft 1464 could be regarded as a part of the movable member 1465.

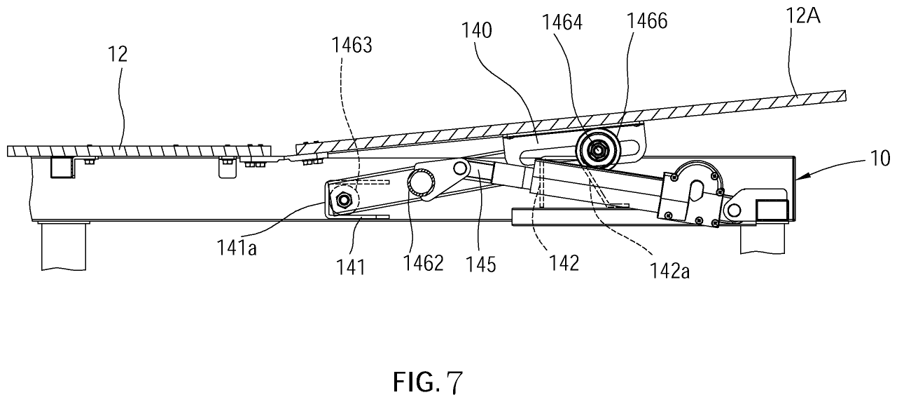

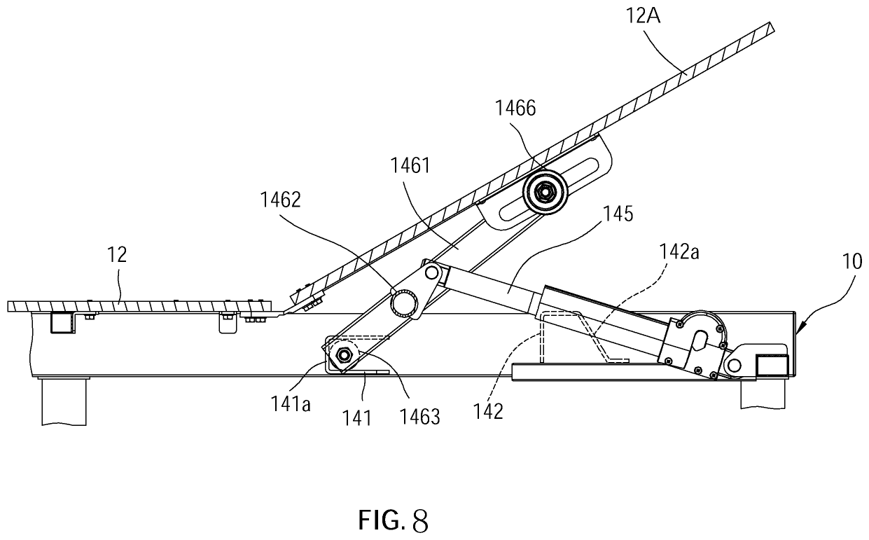

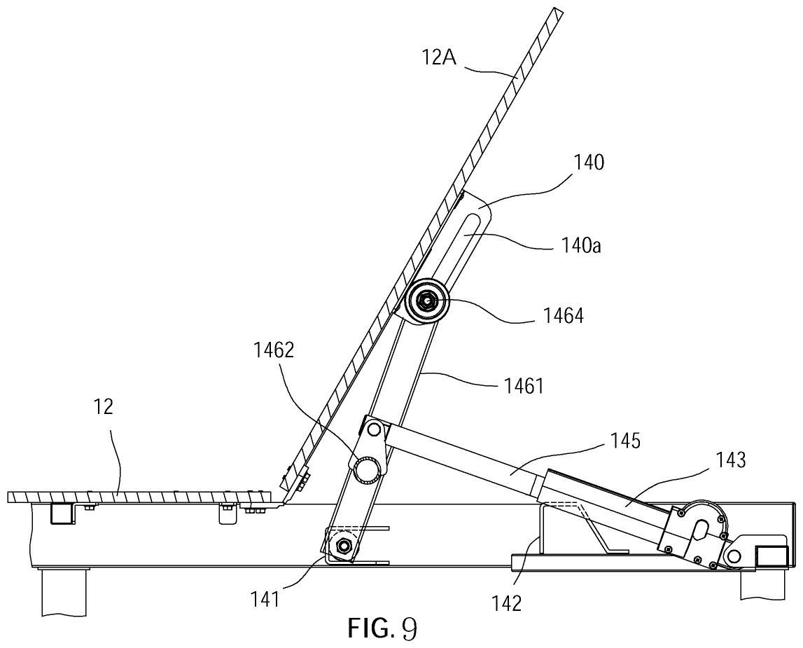

In the aforementioned paragraphs, detailed components and the structures of the plate lifting device 14 for manipulating the plate 12A of the present invention are explained, while the operation thereof will be described in detail herein. As shown in FIG. 1 and FIG. 6, the plate 12A is in a flattened state, and the retractable shaft 145 in this state is defined as being in an initial state, and the user could lay on his/her back on the plate 12A at this time. As shown in FIG. 7, when the motor 144 drives the retractable shaft 145 to extend toward the second push rod 1462, the retractable shaft 145 pushes the second push rod 1462 to move, and indirectly causes the pivoting members 1463 to slide in the sliding space of the restricting members 141. At this time, the movable members 1465 are in contact with the slope 142a of the lifting mechanisms 142, and are operatively coupled to the plate 12A via the shafts 1464 and the driven members 140. As shown in FIG. 8, after the pivoting member 1463 being in contact with the side plate 141a which is defined as the abutted portion, the first push rod 1461 is pivoted around the pivoting member 1463. As the retractable shaft 145 continues to extend, the movable members 1465 will move up on the inclined plane of the slope 142a, and then the roller 1466 pushes the plate 12A, whereby to lift the plate 12A. As shown in FIG. 9, the plate 12A is manipulated to reach a maximum raised angle position by the relationship between the elongated hole 140a of the driven members 140 and the shaft 1464, and the plate body 12A in this state could support the user's back.

In contrast, when the motor 144 is reversed, the retractable shaft 145 is retracted in an opposite direction, and the second push rod 1462 is pulled to change the plate 12A back to the flattened state. It shall be noted that, the retractable shaft 145 could be controlled at a predetermined position that is extended or retracted, whereby to stop the plate 12A at a predetermined inclination angle that the user feels comfortable.

It is worth mentioning that, in the current embodiment, the movable members 1465 for being in contact with the lifting mechanisms 142 is a roller as an example. However, in other embodiments, the movable members could be a sliding member, which is not rotatable, with a curved surface. In other words, the same guiding effect could be obtained by contacting the curved surface of the sliding member with the inclined plane of the slope. In addition, the structure for being in contact with the movable members 1465 and guiding the lifting mechanisms 142 moving upward is not limited by the metal plate bent to include the slope 142a with an inclined plane, but could be a rotatable fixed wheel (not shown). For instance, when the motor 144 pushes the retractable shaft 145 to extend from the initial state, the movable members 1465 would rise along a surface of the rotatable fixed wheel, and the rotatable fixed wheel would also rotate to avoid excessive friction with each other. In this way, the movable members could be lifted as well.

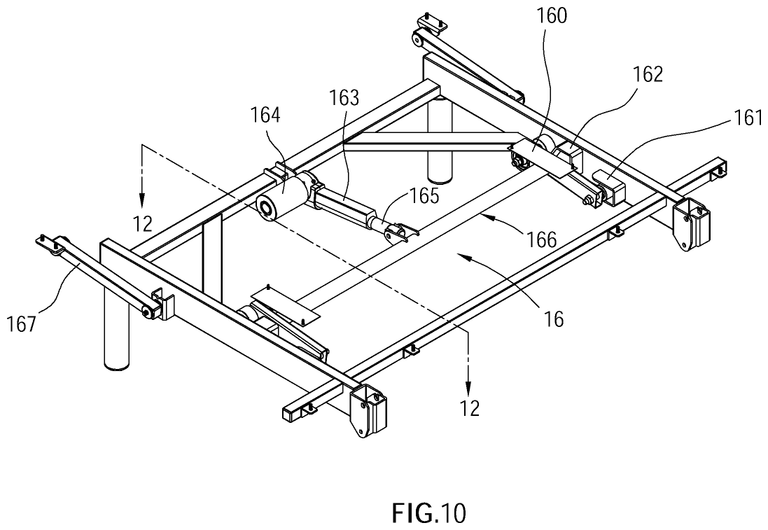

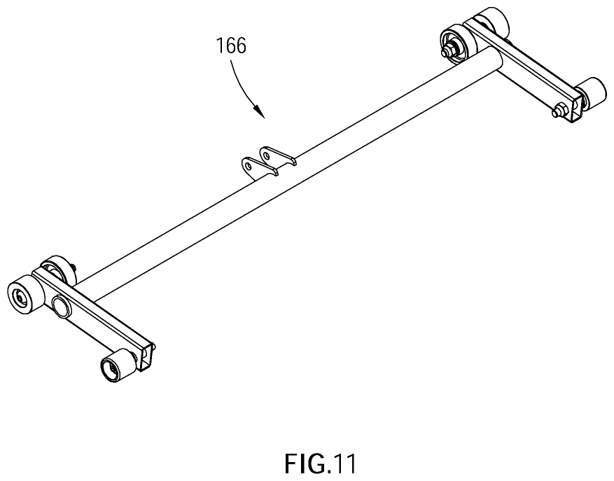

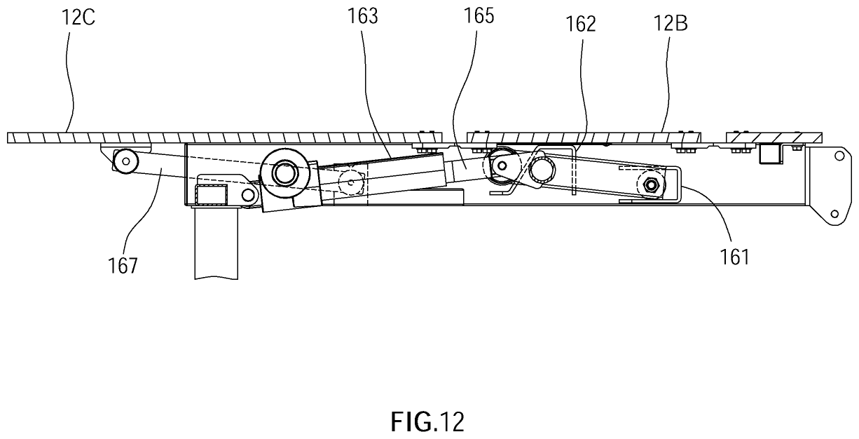

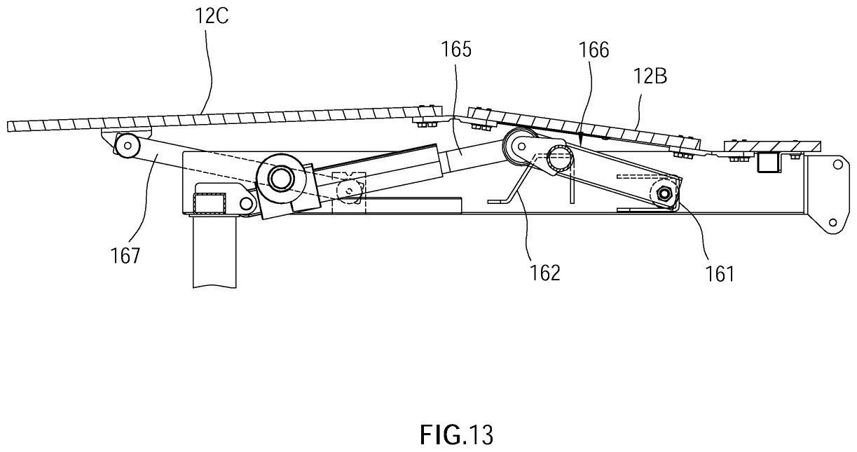

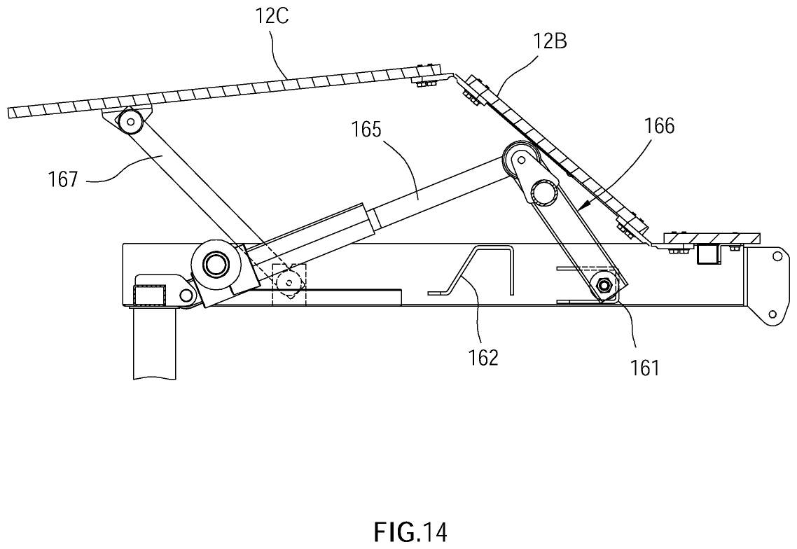

The plate lifting device of the present invention is also applicable to control the plate 12B and the plate 12C, and only some of the components are slightly different, but the overall control action is the same, as explained later. As shown in FIG. 10 to FIG. 14, a plate lifting device 16 is disposed below the plate 12B and the plate 12C and includes two restricting members 161, two lifting mechanisms 162, an axle tube 163, a motor 164, a retractable shaft 165, and a push rod assembly 166, which have the same structure as the restricting members 141, the lifting mechanisms 142, the axle tube 143, the motor 144, the retractable shaft 145 and the push rod assembly 146 respectively. The difference between the plate lifting device 16 and the plate lifting device 14 is that two driven members 160 of the plate lifting device 16 fixed on a bottom surface of the plate 12B has no elongated hole. In addition, a connecting shaft 167 is pivotally connected between the base 10 and the plate 12C. In this way, since the connecting shaft 167 has a fixed length, the plate 12B and the plate 12C are bent within a limited range when the plate 12B is lifted (as shown in FIG. 2 and FIG. 3), so that the user's legs could be supported or properly flexed and stretched.

With the aforementioned design, the lifting device of the present invention could smoothly lift the plates of the multi-plate equipped apparatus such as a lifting bed from a horizontal state, and could prevent the components of the multi-plate equipped apparatus from being damaged due to pushing each other during the lifting process. However, the lifted object is not limited by the lifting bed, but could be any object that needs to be lifted and displaced.

It must be pointed out that the embodiments described above are only some preferred embodiments of the present invention. All equivalent structures which employ the concepts disclosed in this specification and the appended claims should fall within the scope of the present invention.

What is claimed is:

1. A plate lifting device, which is applied to a lifted object; the plate lifting device comprising:
a base;
a push rod assembly which includes a first push rod and a second push rod, wherein the first push rod extends toward a first direction and includes a first end and a second end; the first end is slidable and is pivotally connected to the base; a movable member is disposed on the second end and is operatively coupled to the lifted object; the second push rod is connected to the first push rod at where between the first end and the second end and extends toward a second direction which is perpendicular to the first direction;
a retractable shaft, wherein an end of the retractable shaft is pivotally connected to the second push rod; the retractable shaft is capable of extending toward the second push rod to push the second push rod, and is capable of retracting in an opposite direction to pull the second push rod;
a motor driving the retractable shaft to extend or retract; and
a lifting mechanism which corresponds to the movable member and is disposed on the base, wherein when the motor drives the retractable shaft to extend from an initial state, the retractable shaft abuts against the second push rod, so that the movable member is in contact with the lifting mechanism and is lifted by the lifting mechanism, whereby the lifted object is raised by the movable member.

2. The plate lifting device of claim 1, further comprising a restricting member disposed on the base, wherein the restricting member has a sliding space and an abutted portion connected to the sliding space; the first end of the first push rod has a pivoting member disposed in the sliding space; when the retractable shaft continues to extend from the initial state, the pivoting member slides in the sliding space.

3. The plate lifting device of claim 1, wherein the lifting mechanism comprises a slope; the slope has an inclined plane facing toward a direction away from the first end; when the retractable shaft extends from the initial state, the movable member moves upward along the inclined plane, and is lifted by the inclined plane.

4. The plate lifting device of claim 1, wherein the movable member comprises a roller;
when the motor drives the retractable shaft to extend from the initial state, the roller rolls upward on the lifting mechanism.

5. The plate lifting device of claim 1, further comprising at least one driven member, wherein the at least one driven member is adapted to be connected to the lifted object and has an elongated hole for being passed by the movable member, so that the movable member is operatively coupled to the lifted object; when the movable member is in contact with the lifting mechanism and is lifted by the lifting mechanism, the driven member and the lifted object are raised by the movable member.

6. A lifting bed, comprising:
a base;
a plurality of plates disposed on the base; and
a plate lifting device which is disposed between the base and the plates, wherein the plate lifting device comprises:
a push rod assembly which includes a first push rod and a second push rod, wherein the first push rod extends toward a first direction and includes a first end and a second end; the first end is slidable and is pivotally connected to the base; a movable member is disposed on the second end and is operatively coupled to one of the plates; the second push rod is connected to the first push rod at where between the first end and the second end and extends toward a second direction which is perpendicular to the first direction;
a retractable shaft, wherein an end of the retractable shaft is pivotally connected to the second push rod; the retractable shaft is capable of extending toward the second push rod to push the second push rod, and is capable of retracting in an opposite direction to pull the second push rod;
a motor driving the retractable shaft to extend or retract; and
a lifting mechanism which corresponds to the movable member and is disposed on the base, wherein when the motor drives the retractable shaft to extend from an initial state, the retractable shaft abuts against the second push rod, so that the movable member is in contact with the lifting mechanism and is lifted by the lifting mechanism, whereby the lifted object is raised by the movable member.

7. The lifting bed of claim 6, wherein the plate lifting device comprises a restricting member disposed on the base, wherein the restricting member has a sliding space and an abutted portion connected to the sliding space; the first end of the first push rod has a pivoting member disposed in the sliding space; when the retractable shaft continues to extend from the initial state, the pivoting member slides in the sliding space.

8. The lifting bed of claim 6, wherein the lifting mechanism comprises a slope; the slope has an inclined plane facing toward a direction away from the first end; when the retractable shaft extends from the initial state, the movable member moves upward along the inclined plane, and is lifted by the inclined plane.

9. The lifting bed of claim 6, wherein the movable member comprises a roller; when the motor drives the retractable shaft to extend from the initial state, the roller rolls upward on the lifting mechanism.

10. The lifting bed of claim 6, wherein the plate lifting device comprises at least one driven member, wherein the at least one driven member is adapted to be connected to the lifted object and has an elongated hole for being passed by the movable member, so that the movable member is operatively coupled to the plates; when the movable member is in contact with the lifting mechanism and is lifted by the lifting mechanism, the driven member and the plates are raised by the movable member.
